(19) United States
(12) Patent Application Publication
(10) Pub. No.: US 2026/0223069 A1
(43) Pub. Date: Jul. 30, 2026

(54) NOTIFICATION METHOD AND NOTIFICATION APPARATUS

(71) Applicant: Telefonaktiebolaget LM Ericsson (publ), Stockholm (SE)

(72) Inventor: Yanping DANG, Beijing (CN)

(21) Appl. No.: 19/143,513

(22) PCT Filed: Dec. 27, 2022
(86) PCT No.: PCT/CN2022/142348

§ 371 Date: Jun. 26, 2025

(51) Int. Cl. H04W 68/02

(52) U.S. Cl. CPC H04W 68/02

(57) ABSTRACT

Embodiments of the present disclosure provide a notification method and a notification apparatus. The notification method for notification may include: receiving an event report from a first device; generating a notification based on the event report; determining a second device near the user physically; sending the notification to the second device for notifying the user.

### TECHNICAL FIELD

The non-limiting and exemplary embodiments of the present disclosure generally relate to the technical field of information processing, and specifically to a method and an apparatus for notifying an event to a user.

### BACKGROUND

This section introduces aspects that may facilitate a better understanding of the disclosure. Accordingly, the statements of this section are to be read in this light and are not to be understood as admissions about what is in the prior art or what is not in the prior art.

Currently, Internet of Things (IoT) is becoming more and more popular and facilitates people's work and life in various ways. Things are being connected and become intelligent. Generally, IoT devices are connected to a control device (e.g., a hub device, or sometimes a mobile phone) and communicate with the control device. Connectivity may be achieved through WiFi, wired network, Bluetooth, infrared, Zigbee, 4G, 5G, or other communication technologies.

When an event happens, for example, a washer has done its job and the clothes in it are ready to be picked, the washer may notify a user by an alarm sound. However, if the user is watching TV in a living room which is away from a laundry room or a bathroom where the washer is located, the user may not hear the alarm sound. Or the user wants to pick up the wet clothes after a song being broadcast in TV is over. However, after the song, the user may forget to pick up the wet clothes and it is bad to clothes and user's health.

In another scenario, when the user is watching a TV show and an advertisement is inserted. The user may want to go to the bathroom to avoid the advertisement. One prior art is when the TV detects the user's left, the TV increases a volume of the advertisement so that the user can still hear the advertisement far away from the TV. This may harm the user's ear and may be noise to the user or the user's family members.

There is a need to develop a technology of notifying the user so that the user can be easily and conveniently informed without feeling annoyed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

To overcome or mitigate at least one of the above mentioned problems or other problems or provide a useful solution, embodiments of the present disclosure propose a method and an apparatus for controlling access right of a person for entering a place physically.

In a first aspect of the disclosure, there is provided a notification method for sending notification to a user. The method comprises: receiving an event report from a first device; generating a notification based on the event report; determining a second device near the user physically; and sending the notification to the second device for notifying the user.

In an embodiment, at least one of the first device and the second device is Internet of Things (IoT) device.

In an embodiment, the determining a second device near the user physically comprises: locating a position of the user; locating one or more third devices whose distances with respect to the user are less than a preset threshold; and selecting the second device from the one or more third devices.

In an embodiment, the selecting the second device from the one or more third devices comprises: selecting the nearest third device to the user, as the second device.

In an embodiment, the selecting the second device from the one or more third devices comprises: selecting the third device attached to the user's body, as the second device.

In an embodiment, the selecting the second device from the one or more third devices comprises: selecting the third device which belongs to clothes or shoes, as the second device.

In an embodiment, the selecting the second device from the one or more third devices comprises: selecting the third device with a display and/or a speaker and/or a haptic function, as the second device.

In an embodiment, the selecting the second device from the one or more third devices comprises: selecting the third device being used by the user or to be used immediately by the user, as the second device.

In an embodiment, the selecting the second device from the one or more third devices comprises: selecting the second device from the third devices in accordance with preset sequence.

In an embodiment, the selecting the second device from the one or more third devices comprises: selecting a default device among the third devices, as the second device.

In an embodiment, the method further comprises: repeating the steps of determining the second device and sending the notification to the second device, until a feedback from the user or the first device is received.

In an embodiment, the notification comprises the event of the first device.

In an embodiment, the method further comprises: receiving a user condition report from a fourth device, and wherein the notification further comprises the user condition.

In an embodiment, the method further comprises: receiving a user condition report from a fourth device, and wherein the notification further comprises a notifying way based on the user condition.

In an embodiment, the method further comprises: receiving a user condition report from a fourth device, and wherein the selecting the second device from the one or more third devices comprises: selecting the second device from the third devices based on the user condition.

In an embodiment, prior to the step of receiving an event report from a first device, the method further comprises: selecting the user from a list of predefined users.

In a second aspect of the disclosure, there is provided an notification apparatus for sending notification to a user. The apparatus includes: a communication interface; a processor; and a memory coupled to the processor, said memory containing instructions executable by said processor, whereby the apparatus is operative to perform a method according to the first aspect.

In a third aspect of the disclosure, there is provided a computer-readable storage medium storing instructions which when executed by at least one processor, cause the at least one processor to perform the method according to the first aspect.

With the present invention, the user can be notified of event easily and conveniently without feeling annoyed.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of a notification method 100 for sending notification to a user according to an embodiment of the present disclosure;

FIG. 2 shows a flowchart of a method 200 for determining a second device according to an embodiment of the present disclosure; and

FIG. 3 is a block diagram of a notification apparatus for sending notification to a user according to embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that the terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

The present invention can be applied to an environment where multiple devices are connected to a control device and the devices can report their events to the control device, for example, the environment may be a home, a house, a building, a hospital, a cinema, a library, a plant, a clinic, a working place, a school, a kindergarten, etc. The following description will be given in an example scenario of home with a hub as control device, however, the present invention is not limited to it.

In a home, there may be multiple connected devices, such as a TV in the living room, a refrigerator in a kitchen, a tap and a washer in a bathing room, an so on. These devices are all connected to a control device, e.g., a hub or a smart phone. The users may include family members, such as grandpa, grandma, father, mother, boy, girl, etc.

The father may open the washer, put in clothes and start the laundry process. The washer may identify the identity of user as the father, by e.g., fingerprint on a button or face recognition from a camera built in the washer or connected to the washer. After the washer finishes the laundry process, it may start an alarm to alert everyone that the washing job is done. In order to make people hear the alarm from any place in the home, a volume of the alarm may be large so that it is quite annoying, especially to people who do not have to know this. At the same time, when the father is wearing an ear phone listening to music in another room far away from the bathroom, the father may not hear the alarm.

An approach may be that the washer sends a message to the hub that the laundry process is done and all the smart devices that can display message will receive the message from the hub and display the message. In this approach, the father may also not receive the message because he is listening to music with his eyes closed. And it is also annoying if everyone have to see the message in his/her device, for example, the boy is learning with a pad and suddenly the message is prompted and the TV grandpa is watching also prompt the message. The father also feel annoyed when he see this message everywhere.

In another approach, the washer sends a message to a mobile phone of the father because the mobile phone is bonded to the washer in advance. The father may not receive the message if he is not carrying the mobile phone and the mother may not receive the message if the mother does the laundry sometimes.

That is to say, devices can only push prompt messages to family members according to fixed configuration which lack the ability to dynamically adjust targeted person and/or proper device according to real-time position. Then it may lead to miss or ignorance of prompt messages from devices.

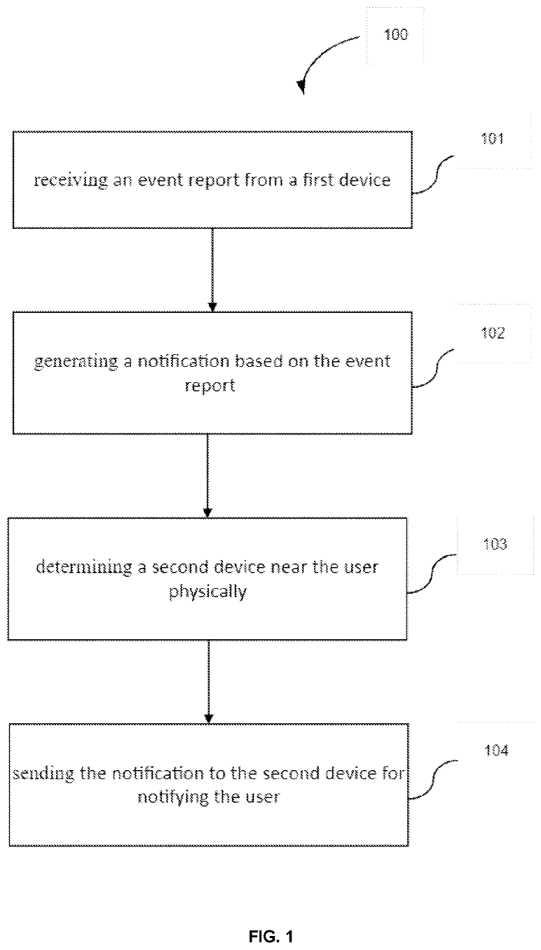

FIG. 1 shows a flowchart of a notification method 100 for sending notification to a user according to an embodiment of the present disclosure.

The method 100 may be implemented in the control device, or any other suitable device. Alternatively, the method 100 may be partially implemented in one device, partially implemented in another device and/or partially implemented in the cloud. The method may also be implemented fully in the cloud.

At block 101, an event report from a first device is received.

The first device may be any smart device that can connect and report its event (including, but not limited to its status, working history, log information, ID, time, etc.). For example, the first device may be an IoT device, such as a washer, an oven, a lock, a switch, a TV, a refrigerator, a health monitor device, a smart phone, an air conditioner, a tap, a vehicle, a power, a charging device, a camera, a meter, a microphone, a gas sensor, a bicycle, a motorbike, etc.

The first device may generate the event report reporting its event and send it to the hub. The event report may be, for example, that the washer finishes the laundry process, the refrigerator door is open for a time period longer than threshold, the oven is on without heating anything according to its sensor, the gas sensor senses gas leakage, or the car is not locked with no one inside, etc.

The hub may receive from the first device such event report.

At block 102, a notification based on the event report is generated.

After receiving the event report, the hub may generate a notification based on the event report.

In an embodiment, the hub may simply forward the event report. That is, the notification has the same content as the event report.

In another embodiment, since the first device is not limited to one device, the hub may receive multiple event reports from multiple first devices and generate the notification based on the multiple event reports. For example, the notification may be a summary of the multiple event reports, or the notification may be a list of events classified in groups and/or prioritized in sequence, etc.

At block 103, a second device near the user physically is determined.

In this step, a proper device for notifying the user with the notification is decided, i.e., the second device. The second device may also be the devices listed above for the first device.

The second device need to be a device physically near the user so that the user can be directly notified without disturbing others. Term “near” means the distance between the user and the second device is within a threshold.

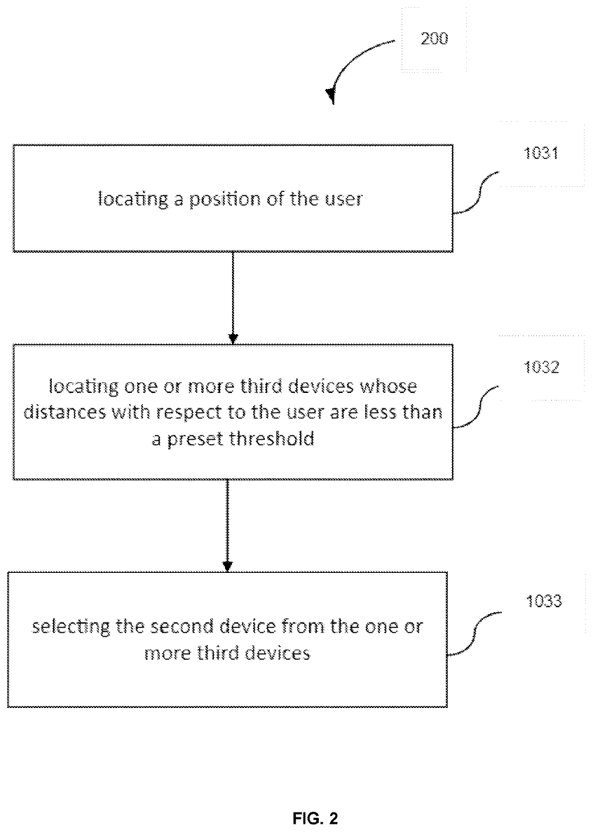

FIG. 2 shows a flowchart of a method 200 for determining a second device according to an embodiment of the present disclosure.

In an embodiment, the step of block 103 may be implemented by the following steps.

At block 1031, a position of the user is located.

The user's position may be obtained by a radar, an infrared sensor, a camera, a wearable being worn by the user, a device moving (implying it is being carried by the user), or a motion sensor, etc., based on face recognition algorithm, face/human tracking, short range connection, signal strength, access point, or any other suitable positioning technology. The user may move so the position of the user may be updated.

The user's position may be an accurate position within the home, or may be a relative position with respect to the hub, or may be at room-level, e.g., in kitchen, in living room, etc.

At block 1032, one or more third devices whose distances with respect to the user are less than a preset threshold is located.

The third devices are those devices that are connected to the hub and whose positions are known to the hub and the third device has the capability to notify the user. For example, the camera, the motion sensor and/or infrared sensor are installed at fixed positions and their positions may be logged in the hub during/after installation, by e.g., user input or sensed by a device and reported to the hub. When the camera senses the user entering into the kitchen where the camera is installed, it can be determined that the camera and the user are within the same room. When the user opened the refrigerator, it can be determined that the distance between the refrigerator and the user is less than the distance between the camera and the user. As another example, the bicycle as the third device may be connected to the user's phone he is carrying via Bluetooth so that the distance between bicycle and the user is quite small. As yet another example, wearables and mobile phones may sense the user to be nearby/be carrying/wearing the wearables by detecting heartbeat or body temperature, via infrared, or movement of themselves. As yet another example, a TV may detect eyes or a face of a user and the TV is determined as the third device.

The third devices are candidates for the second device. The preset threshold may be set by those skilled in the art according to requirements.

At block 1033, the second device is selected from the one or more third devices.

The second device may be one most suitable device to avoid multiple devices notifying the user with the same content or may be a small number of devices to make sure the user gets the notification.

In an embodiment, the second device may be selected from the one or more third devices by selecting the nearest third device to the user, as the second device. For example, when the user is in the kitchen cooking by the oven, the oven is selected rather than the TV in the living room. Alternatively, some or all devices in the kitchen are selected.

In an embodiment, the second device may be selected from the one or more third devices by selecting the third device attached to the user's body, as the second device. For example, the wearables, such as a watch, a wristband, a bandage, a patch, glasses, a body monitoring device, or a hairpin.

In an embodiment, the second device may be selected from the one or more third devices by selecting the third device which belongs to clothes or shoes, as the second device. For example, shoes, haptic shoes, a haptic brioche, or a swimming suit with haptic module, etc.

In an embodiment, the second device may be selected from the one or more third devices by selecting the third device with a display and/or a speaker and/or a haptic function, as the second device. For example, a display and/or a speaker of a car, a windshield of a car, a display and/or a speaker of a TV, a display of a refrigerator, a display and/or a speaker of a bicycle, a haptic shoes or a haptic brioche, etc.

In an embodiment, the second device may be selected from the one or more third devices by selecting the third device being used by the user or to be used immediately by the user, as the second device. For example, a TV may detect eyes or a face of the user and the TV is being used by the user. As another example, a camera at the door or a door lock may detect eyes or a face of the user and the door lock is to be used immediately by the user. As yet another example, an oven is turned on and the oven is to be used immediately by the user. As another example, a tap is turned on and the dressing mirror behind the tap is being used or to be used immediately by the user.

In an embodiment, the second device may be selected from the one or more third devices by selecting the second device from the third devices in accordance with preset sequence. The preset sequence of devices may be set before shipping out of a factory or may be set by a user.

In an embodiment, the second device may be selected from the one or more third devices by selecting a default device among the third devices, as the second device. Default device may be a mobile phone or wearables, or a hub, etc.

At block 104, the notification is sent to the second device for notifying the user.

The second device may notify the user with the notification by sound, light, alarm, voice, text, image, pattern, video, cartoon, or dialog box, etc.

With the embodiments of the present invention, a second (one or more second device) suitable for notifying the user is selected to notify the user, where the second device near the user to be notified may notify the user and other devices may not disturb the user or any other person so that the user can get the notification easily and conveniently without feeling annoyed.

In another embodiment of the present invention, in addition to the characteristics of the above embodiments, a user condition report is further received by the hub from a fourth device. The user condition may be sensed by the fourth device and conveyed to the hub. The user condition represents a certain condition/status of the user. For example, sleeping, passing out, going out of the door, heart rate above preset value, driving, riding a bicycle, etc.

In the embodiment, the notification way of notifying the user is determined by the user condition. For example, when the user condition is sleeping or passing out, the volume of the notification is increased, or to use the alarm/voice/sound rather than text/video as notification, or the notification is sent to default/preset user or emergency number/platform.

The notification way may be determined by the hub, in which case the notification from the hub to the second device also include the notification way based on the user condition.

The notification way may be determined by the second device, in which case the notification from the hub to the second device also include the user condition.

The selection of the second device from the third devices may also based on the user condition. For example, when the user condition is driving, the following third devices are preferably selected: windshield of the vehicle, head up display (HUD), navigation screen, or speaker. When the user condition is riding a bicycle, the following third devices are preferably selected: display or speaker of the bicycle, haptic device/module, or speaker of mobile phone/watch.

The above embodiments may also include step of selecting the user from a list of predefined users. For example, in a home scenario, family members are in the list of users for selection. The hub may select the user to be notified. For example, when detecting that father opens and starts the washer, the father is the user selected to be notified. In another example, users may be associated with the first device or the second device in advance and the associated user may be selected to be notified.

The user may get the notification or may overlook the notification or the user is moving, so the steps of determining the second device and sending the notification to the second device may be repeated until a feedback from the user or the first device is received. The feedback may include e.g., the opening of the washer after the laundry process, the weight sensor of the washer detecting less weight, the oven switch being turned off, the acknowledgement button on the mobile phone being pressed/tapped, the refrigerator being remotely controlled to close the door, etc.

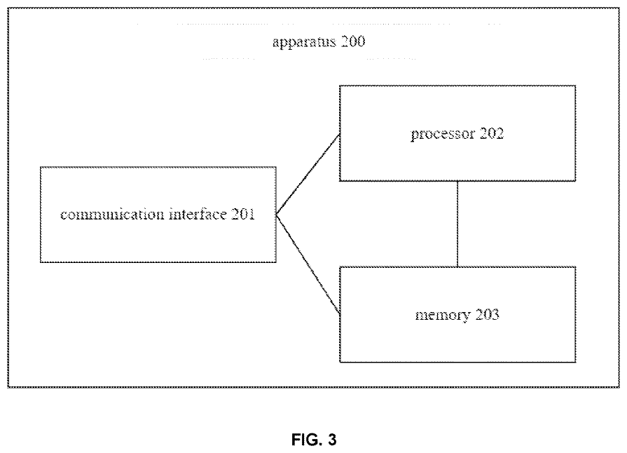

FIG. 3 is a block diagram of a notification apparatus for sending notification to a user according to embodiments of the present disclosure.

The apparatus 200 includes a communication interface 201, a processor 202 and a memory 203. The memory 203 contains instructions executable by the processor 202 whereby the apparatus 200 is operative to perform the actions, e.g., of the procedure described earlier in conjunction with FIGS. 1 and 2.

In some embodiments, the memory 203 may further contain instructions executable by the processor 202 whereby the apparatus 200 is operative to perform any of the aforementioned methods, steps, and processes.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 202 causes the apparatus 200 to perform the actions, e.g., of the procedure described earlier in conjunction with FIGS. 1 and 2.

The computer program product may be configured as a computer program code structured in computer program modules. The computer program modules could essentially perform the actions of the flow illustrated in FIGS. 1 and 2.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations arc considered to be within the scope of the disclosure and the appended claims. The protection scope of the disclosure is defined by the accompanying claims.

1. A notification method for sending notification to a user, comprising:
receiving an event report from a first device;
generating a notification based on the event report;
determining a second device near the user physically; and
sending the notification to the second device for notifying the user.

2. The method of claim 1, wherein at least one of the first device and the second device is an Internet of Things (IoT) device.

3. The method of claim 1, wherein the determining a second device near the user physically comprises:
locating a position of the user;
locating one or more third devices whose distances with respect to the user are less than a preset threshold; and
selecting the second device from the one or more third devices.

4. The method of claim 1, wherein the selecting the second device from the one or more third devices comprises:
selecting the nearest third device to the user, as the second device.

5. The method of claim 1, wherein the selecting the second device from the one or more third devices comprises:
selecting the third device attached to the user's body, as the second device.

6. The method of claim 1, wherein the selecting the second device from the one or more third devices comprises:
selecting the third device which belongs to clothes or shoes, as the second device.

7. The method of claim 1, wherein the selecting the second device from the one or more third devices comprises:
selecting the third device with a display and/or a speaker and/or a haptic function, as the second device.

8. The method of claim 1, wherein the selecting the second device from the one or more third devices comprises:
selecting the third device being used by the user or to be used immediately by the user, as the second device.

9. The method of claim 1, wherein the selecting the second device from the one or more third devices comprises:
selecting the second device from the third devices in accordance with a preset sequence.

10. The method of claim 1, wherein the selecting the second device from the one or more third devices comprises:
selecting a default device among the third devices, as the second device.

11. The method of claim 1, further comprising:
repeating the steps of determining the second device and sending the notification to the second device, until a feedback from the user or the first device is received.

12. The method of claim 1, wherein the notification comprises the event of the first device.

13. The method of claim 1, further comprising:
receiving a user condition report from a fourth device,
and wherein the notification further comprises the user condition.

14. The method of claim 1, further comprising:
receiving a user condition report from a fourth device,
and wherein the notification further comprises a notifying way based on the user condition.

15. The method of claim 1, further comprising:
receiving a user condition report from a fourth device, and
wherein the selecting the second device from the one or more third devices comprises:
selecting the second device from the third devices based on the user condition.

16. The method of claim 1, wherein prior to the step of receiving an event report from a first device, the method further comprises:
selecting the user from a list of predefined users.

17. A notification apparatus for sending notification to a user, comprising:
a communication interface;
a processor; and
a memory coupled to the processor, said memory containing instructions executable by said processor, whereby the apparatus is operative to perform a method according to claim 1.

18. A non-transitory computer-readable storage medium storing instructions which when executed by at least one processor, cause the at least one processor to perform the method according to claim 1.
